(19) United States
(12) Patent Application Publication
(10) Pub. No.: US 2004/0128421 A1
(43) Pub. Date: Jul. 1, 2004

(54) Apparatus and method for providing upgraded system memory for mobile platforms using mobile docking stations

(75) Inventor: Brian S. Forbes, Portland, OR (US)

Correspondence Address: KENYON & KENYON, 1500 K STREET, N.W., SUITE 700, WASHINGTON, DC, 20005, US

(73) Assignee: INTEL CORPORATION

(21) Appl. No.: 10/330,182

(22) Filed: Dec. 30, 2002

(51) Int. Cl. G06F 13/00

(52) U.S. Cl. 710/303

(57) ABSTRACT

Docking computers, and in particular, a system memory bus tap to provide an external means to connect to a docking station with additional system memory to increase the amount of system memory available to the docking computer. In accordance with an embodiment of the present invention, a portable device including a system memory, a system memory bus coupled to the system memory, a memory controller coupled to the system memory bus, a system memory bus tap coupled to the first system memory bus and a system memory bus tap link coupled to the system memory bus tap. The first system memory bus tap link to couple to an external system memory and said memory controller to control data transfer requests for data stored in said system memory and said external system memory.

### FIELD OF THE INVENTION

The present invention pertains to docking computers, and in particular, a system memory bus tap to provide an external means to connect to a docking station with additional system memory to increase the amount of system memory available to the docking computer.

### BACKGROUND

As portable computers continue to become more powerful, their use as replacements for desktop computers has continued to rise. At the desktop, portable computers may be docked to docking base units for convenient access to additional resources, including a network, a printer, mass storage devices such as hard disk drives, compact disks (CD) or digital video disk (DVD) drives, and other types of peripheral devices. By using a docking unit, such peripheral resources become available once the portable computer is docked.

Various types of docking solutions exist. One includes a docking connector that couples an expansion or secondary bus in the portable unit to a corresponding bus in the docking base unit. Another type of system includes docking connectors that couple a Peripheral Component Interconnect (PCI) bus, such as described in the PCI Local Bus Specification, Revision 2.2, published in Dec. 18, 1998, in the portable computer to a PCI bus in the docking base unit.

Unfortunately, current computer docking stations do not contain the necessary high-speed bus connectivity and additional system memory that can be used by a portable computer when the portable computer is connected to the computer docking station. Likewise, current portable computers do not contain the necessary connectivity to access additional system memory were it available in the computer docking stations.

### BRIEF DESCRIPTION OF THE DRAWINGS

FIG. 1 is a block diagram of a current apparatus for docking a portable computer with a docking station.

FIG. 2 is a detailed block diagram of an apparatus for connecting a portable computer to additional system memory in a docking station, in accordance with an embodiment of the present invention.

FIG. 3 is a flow diagram of a method of performing data input/output in a processor from a system memory external to the processor, in accordance with an embodiment of the present invention.

FIG. 4 is a flow diagram of a method of performing data input/output in a processor having a system memory local to the processor, a system memory external to the processor and a mass memory, in accordance with an embodiment of the present invention.

FIG. 5 is a detailed block diagram of an alternate apparatus for connecting a portable computer to additional system memory in a docking station, in accordance with an embodiment of the present invention.

### DETAILED DESCRIPTION

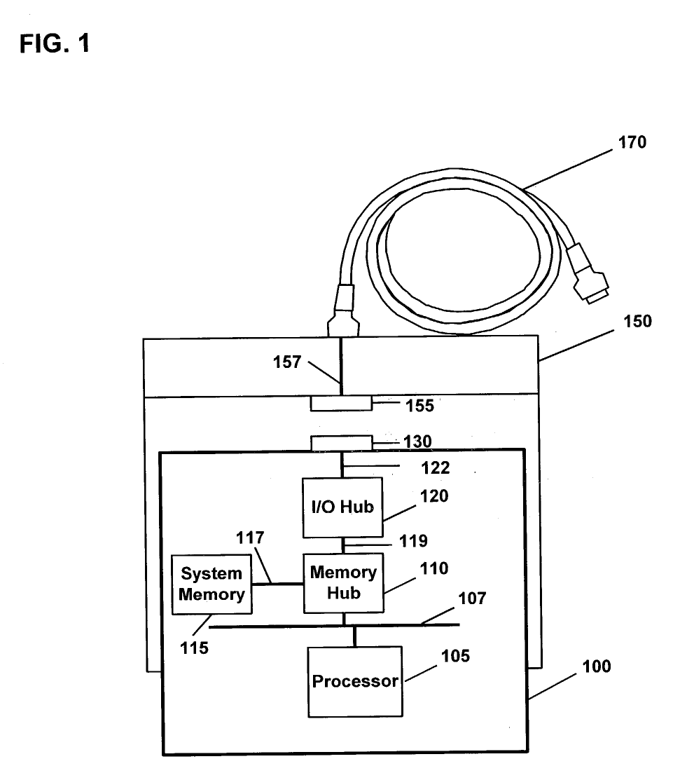

FIG. 1 is a block diagram of a current apparatus for docking a portable computer with a docking station. In FIG. 1, a portable computer 100 may include a processor 105, which may be coupled to a host bus 107, and a memory hub (controller) 110, which may be coupled to host bus 107. Host bus 107 may be a single or multiprocessor bus interface. Portable computer 100 may also include a system memory 115, which may be coupled to memory hub 110 via a memory bus 117. Memory bus 117 may be an SDR (Single Data Rate) S-DRAM (Synchronous Dynamic Random Access Memory), DDR (Double Data Rate) S-DRAM, or R-DRAM (Rambus DRAM) memory bus interface and all memory bus interfaces may support Error Correcting code (ECC) or non-ECC memory. Host bus 107 and memory bus 117, generally, are derivatives of a main system clock, or host clock, implemented in portable computer 100. Common main system clock speeds implemented in today's portable computers include 100 megahertz (MHz) and 133 MHz. Memory hub 110 may also be coupled to an input/output (I/O) hub 120 via a link 119. I/O hub 120 may also be coupled to a docking interface 130 via a bus 122. For example, bus 122 may be a Peripheral Component Interconnect (PCI) bus per PCI Special Interest Group (SIG) PCI Local Bus Specification, Revision 2.2, published Dec. 18, 1998; an industry standard architecture (ISA) bus; an Extended ISA (EISA) buses, BCPR Services Inc. EISA Specification, Version 3.12, 1992, published 1992; an universal serial bus (USB), USB Specification, Version 1.1, published Sep. 23, 1998; and comparable peripheral buses. In general, bus 122 can be coupled to mass memory storage devices, as well as other peripherals, and will operate at a fraction of the speed of the main system clock speed. Common speeds for bus 122 include 33 or 66 MHz. Therefore, since accessing data from system memory is much faster (often by a factor of 3 or more) than accessing data bus 122, maintaining as much data in system memory as possible is highly desirable.

In FIG. 1, a docking station 150 may include a docking station docking interface 155, which may couple to docking interface 130 of portable computer 100. Docking station docking interface 155 may be coupled to a docking station bus 157 to permit access to a variety of external resources. Docking station bus 157 may be coupled to a cable 170, which may permit access to the external resources.

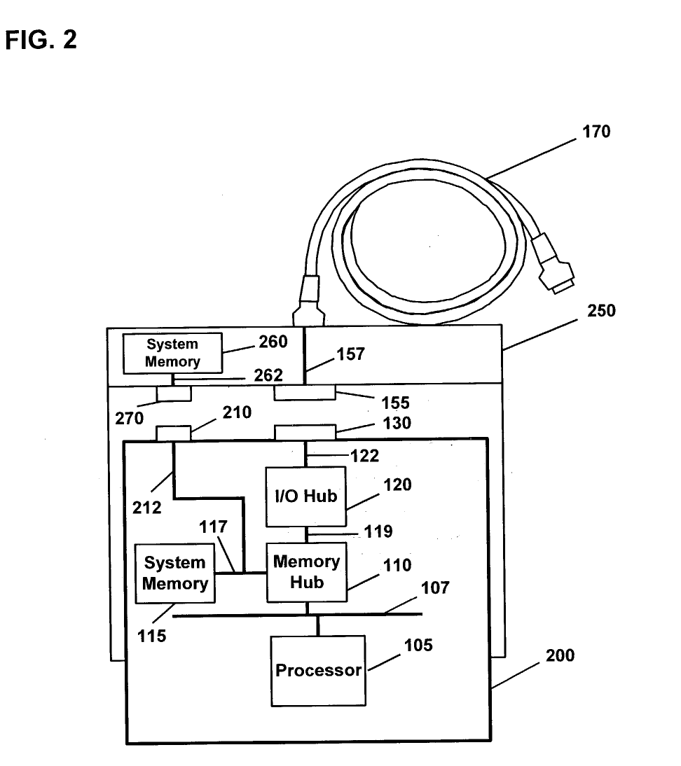

FIG. 2 is a detailed block diagram of an apparatus for connecting a portable computer to additional system memory in a docking station, in accordance with an embodiment of the present invention. In FIG. 2, a portable computer 200 may include the components of portable computer 100 from FIG. 1 along with a system memory bus tap 212 that may be coupled to memory bus 117. Since portable computer 200 may be configured as shown in FIG. 1 and described above, similar structures are identified herein using the same reference numbers as in FIG. 1. Likewise, for consistency and clarity, structures common to more than one figure also will be identified using the original reference number throughout the figures and herein. In FIG. 2, system memory bus tap 212 may also be coupled to a system memory bus tap link 210 to permit connection with external system memory. Although system memory bus tap link 210 is shown in FIG. 2 as being located on the back side of portable computer 200 with docking interface 130, alternative embodiments are contemplated in which system memory bus tap link 210 may be located on any other side of portable computer 200 so as to be accessible when portable computer 200 may be coupled to docking station 250. In these alternative embodiments, system memory bus tap link 210, for example, may be coupled directly to the external system memory or may be coupled via an external cable to the external system memory. In FIG. 2, system memory 115 and docking station system memory 260 may be considered to be in a parallel configuration.

In FIG. 2, as with portable computer 200, docking station 250 may be configured similar to docking station 150 from FIG. 1. Docking station 250 also may include a docking station system memory 260, which may be coupled to a docking station system memory bus 262. In FIG. 2, docking station 250 may also include a docking station system memory bus link 270 coupled to docking station system memory bus 262 to permit coupling with portable computer 200. Although docking station system memory bus link 270 is shown as being located on the same side of docking station 250 as docking station docking interface 155 in FIG. 2, alternative embodiments are contemplated. Specifically, in these alternative embodiments docking station system memory bus link 270 may be located on another side of docking station 250. In these alternative embodiments, docking station system memory bus link 270, for example, may be coupled to system memory 115 in portable computer 200 via an external cable.

In another embodiment in accordance with the present invention, the external system memory may be provided separately from docking station 250, for example, in a separate system memory component (not shown) that may be coupled to system memory bus tap link 210 in portable computer 200 via an external cable.

In accordance with embodiments of the present invention, in FIG. 2, the system memory, regardless of whether it is system memory 115, docking station system memory 260 or an external system memory in a separate component (not shown), may receive power and control signals from portable computer 200. The power and control signals may be supplied to system memory 115 via system memory bus 117 and may be supplied to docking station system memory 260 or a separate external system memory component via system memory bus 117 and system memory bus tap 212. As a result, when portable computer 200 enters or exits a power-saving sleep state, all coupled system memory will also enter the power-saving sleep state. In general, in these embodiments, the external system memory components may only receive power from and be controlled by portable computer 200.

In general, the external system memory in FIG. 2 may be connected to portable computer 200 in a variety of system states. For example, in a first system state, the external system memory may be connected to portable computer 200 in a power off state so that when portable computer 200 is powered-up the external system memory may be detected and initialized for use. In a second system state, the external system memory may be connected to portable computer 200 while it is in a sleep state so that when portable computer 200 “awakens” from the sleep state, the external system memory may be detected and initialized for use. In a third system state, the external system memory may be connected to portable computer 200 while it is in a normal, power on state so that portable computer 200 may detect and initialize the external system memory for use.

In accordance with another embodiment of the present invention, in FIG. 2, docking station system memory 260 may receive power from docking station 250 and control signals from portable computer 200. In docking station 250 the power for docking station system memory 260 may be supplied from the source of power for the docking station as well as from a battery source. In this embodiment, a voltage regulator (not shown) may be required to be included in docking station 250 and additional control signals between portable computer 200 and docking station 250 may also be needed. The additional control signals may be needed to control the system memory power in docking station system memory 260 to enter or exit a power-saving sleep state. The additional control signals may be provided using the existing pin configuration in system memory bus 117 or with a dedicated new circuit. Since docking station system memory 260 will have a separate power source, it may draw power from the separate power source during normal operation while portable computer 200 may be actively running.

In accordance with an embodiment of the present invention, the separate system memory may receive power from the separate system memory component similar to how docking station system memory 260 may receive power from docking station 250. As such, equivalent structures and signals, for example, voltage regulators, logic gates, and control signals may be needed to control the separate system memory power and separate system memory active/sleep states.

It is contemplated that in addition to portable computers (that is, laptops, notebooks, etc.) embodiments of the present invention, may also be used with any other portable computing/processing device capable of accessing system memory and being coupled to external resources. For example, these other devices may include personal digital assistants (PDAs), portable telephones, wireless telephones, portable game systems, MPEG Audio Layer-3 (MP3) players, and digital notepads. For example, MP3 players implemented according to ISO/IEC JTC1/SC29/WG11 MPEG, “International Standard IS 13818-3 Information Technology—Generic Coding of Moving Pictures and Associated Audio, Part 3: Audio”, published 1994; and ISO/IEC JTC1/SC29/WG11 N1229, “MPEG-2 Backwards Compatible CODECS Layer II and III: RACE dTTb Listening Test Report”, Florence, published March 1996.

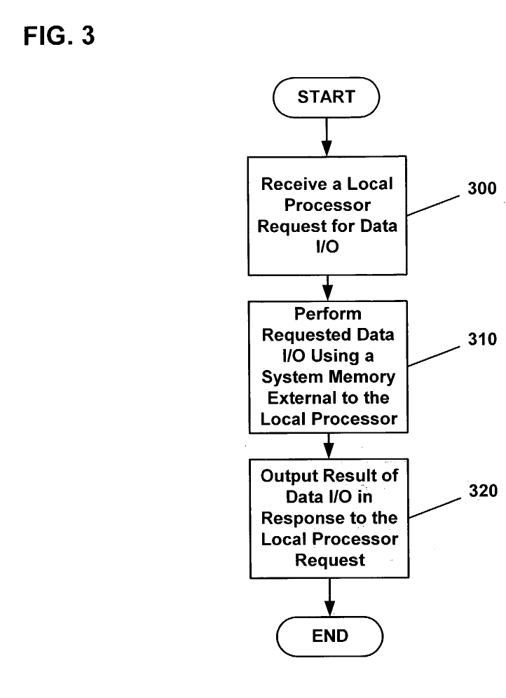

FIG. 3 is a flow diagram of a method of performing data input/output in a processor from a system memory external to the processor, in accordance with an embodiment of the present invention. In FIG. 3, a request for data input/output (I/O) may be received (300), for example, in memory hub 110 of FIG. 2. Returning to FIG. 3, the data I/O may include a data read request or a data write (store) request. In accordance with an embodiment of the present invention, the requested data I/O may be performed (310) by memory hub 110 using a system memory located external to portable computer 200, for example, docking station system memory 260. In accordance with another embodiment of the present invention, the requested data I/O may be performed (310) using a system memory located external to both portable computer 200 and docking station 250 of FIG. 2, for example, a separate system memory component (not shown). In FIG. 3, the result of the data I/O may be output (320), generally, to a local processor, such as, processor 105 of FIG. 2, in response to the request for the data I/O.

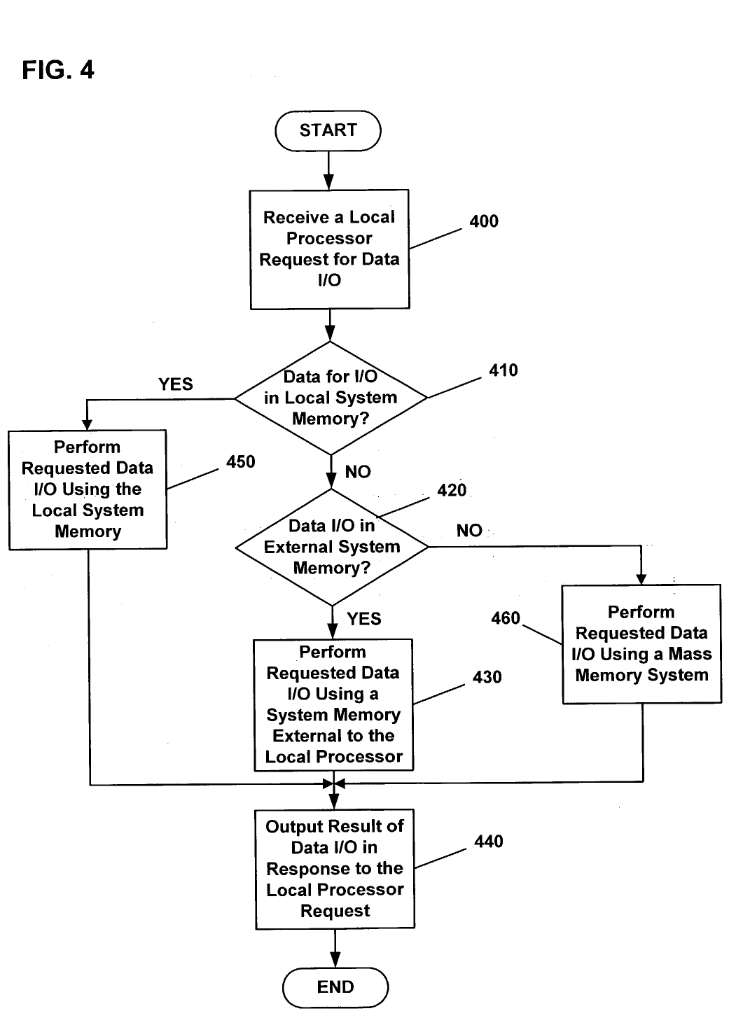

FIG. 4 is a detailed flow diagram of a method of performing data input/output in a processor having a system memory local to the processor, a system memory external to the processor and a mass memory, in accordance with an embodiment of the present invention. In FIG. 4, a request for data input/output (I/O) may be received (400), for example, in memory hub 110 of FIG. 2. Returning to FIG. 4, the data I/O may include a data read request or a data write (store) request. Whether the target of the data I/O is in local system memory, for example, system memory 115, may be determined (410). Whether the target of the data I/O is in an external system memory, for example, docking station system memory 260 or a separate external system memory, may be determined (420), if the target of the data I/O is determined (410) not to be in local system memory. The requested data I/O may be performed (430) by memory hub 110 using a system memory located external to portable computer 200, for example, docking station system memory 260 or the separate external system memory, if the target of the data I/O is in the external system memory. The result of the data I/O may be output (440) in response to the request for the data I/O, generally, to a local processor, such as, processor 105 of FIG. 2.

Alternatively, the requested data I/O may be performed (450) by memory hub 110 using local system memory 115, if the data for the I/O is determined (410) to be in the local system memory. The result of the data I/O may be output (440) in response to the request for the data I/O, generally, to a local processor, such as, processor 105 of FIG. 2.

In accordance with another embodiment of the present invention, the requested data I/O may be performed (460), for example, using a mass memory system located external to portable computer 200, if the data for the I/O is determined (420) not to be in the external system memory. In general, the mass memory system may be coupled to portable computer 200 via bus 122. The mass memory system may be coupled directly to portable computer 200 or coupled to portable computer 200 via docking station 250. A result of the data I/O may be output (440) in response to the request for the data I/O, generally, a local processor, such as, processor 105 of FIG. 2. For example, the result of a data read request may be the requested data, and the result of a data write (store) request may be a signal indicating the success or failure of the write.

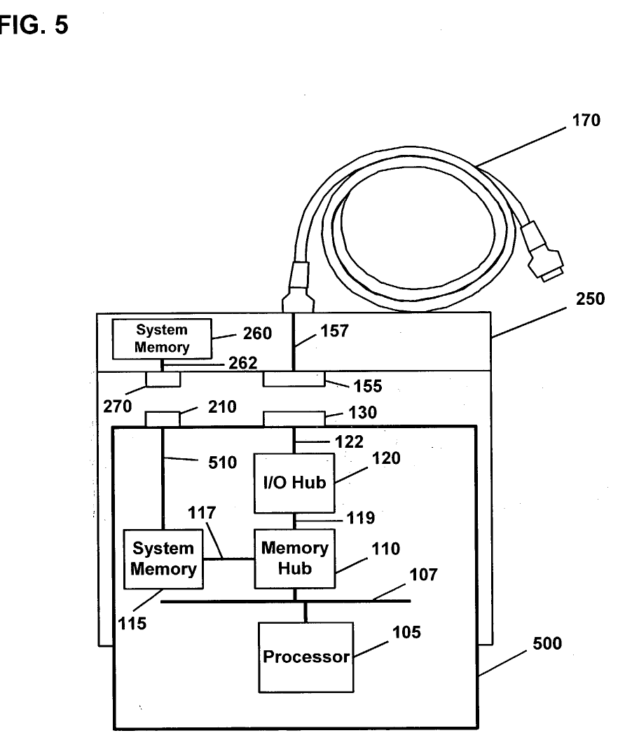

FIG. 5 is a detailed block diagram of an alternate apparatus for connecting a portable computer to additional system memory in a docking station, in accordance with an embodiment of the present invention. In FIG. 5, a portable computer 500 may be configured to be essentially identical to portable computer 200 of FIG. 2, which is described above, with at least one exception. Instead of system memory bus tap 212 of portable computer 200, in FIG. 5, portable computer 500 may instead have a second system memory bus 510 coupled between system memory 115 and a second system memory bus link 520. Second system memory bus link 520 may be the same as system memory bus tap link 212 of FIG. 2, and is merely renamed in FIG. 5 to accurately reflect its origin and function. In this embodiment, system memory 115 and docking station system memory 260 may be considered to be in a serial configuration.

Several embodiments of the present invention are specifically illustrated and described herein. However, it should be appreciated that modifications and variations of the present invention are covered by the above teachings and come within the purview of the appended claims without departing from the spirit and intended scope of the invention.

What is claimed is:

1. A system comprising:
a portable device having a first system memory, a first system memory bus coupled to said first system memory, a memory controller coupled to said first system memory bus and a first system memory bus tap coupled to said first system memory bus, and a first system memory docking link coupled to said first system memory bus tap; and
a docking station having a second system memory, a second system memory bus coupled to said second system memory and a second system memory docking link coupled to said second system memory bus,
said first system memory docking link and said second system memory docking link to couple said first system memory bus and said second system memory bus and said memory controller to control data transfer to and from said first system memory and said second system memory.

2. The system as defined in claim 1 wherein said portable device further comprises:
a processor coupled to said memory controller.

3. The system as defined in claim 1 further comprising:
an input/output controller coupled to said memory controller.

4. The system as defined in claim 3 further comprising:
a third bus coupled to said input/output controller; and
a portable computer docking interface coupled to said third bus.

5. The system as defined in claim 4 wherein said docking station further comprises:
a docking station docking interface; and
a fourth bus coupled to said docking station docking interface, said fourth bus to permit access by said portable device to a resource device coupled to said docking station.

6. The system as defined in claim 5 wherein said portable computer docking interface and said docking station docking interface are to couple said portable device with said docking station.

7. The system as defined in claim 1 wherein said system memory bus tap is to provide power to said external system memory.

8. The system as defined in claim 1 wherein said second system memory is to receive power from said portable device.

9. The system as defined in claim 1 wherein said second system memory is to receive power from said docking station.

10. A portable device comprising:
a system memory, a system memory bus coupled to said system memory, a memory controller coupled to said system memory bus, a system memory bus tap coupled to said first system memory bus and a system memory bus tap link coupled to said system memory bus tap;
said first system memory bus tap link to couple to an external system memory and said memory controller to control data transfer requests for data stored in said system memory and said external system memory.

11. The portable device as defined in claim 10 further comprises:
a processor coupled to said memory controller.

12. The portable device as defined in claim 10 wherein said system memory bus tap is to provide power to said external system memory.

13. The portable device as defined in claim 10 further comprising:
an input/output controller coupled to said memory controller.

14. The portable device as defined in claim 13 further comprising:
a third bus coupled to said input/output controller; and
a portable computer docking interface coupled to said third bus.

15. The portable device as defined in claim 14 wherein said portable computer docking interface is to couple to a docking station docking interface.

16. The system as defined in claim 14 wherein said first system memory bus and said first system memory tap operate at at least twice the speed of said third bus.

17. The system as defined in claim 14 wherein said system memory is random access memory.

18. A portable device comprising:
a system memory, a system memory bus coupled to said system memory, a memory controller coupled to said system memory bus, a second system memory bus coupled to said system memory and a second system memory bus link coupled to said second system memory bus;
said second system memory bus link to couple to an external system memory and said memory controller to control data transfer requests for data stored in said system memory and said external system memory.

19. The portable device as defined in claim 18 wherein said second system memory bus is to provide power to said external system memory.

20. A method comprising:
receiving a processor request to transfer data;
performing the data transfer using a system memory located external to said processor; and
outputting a result of the data transfer.

21. The method as defined in claim 20 wherein said performing operation comprises:
determining a location to be used in the data transfer is not located local to said processor;
determining the data is in said external system memory; and
transferring the data using said external system memory.

22. The method as defined in claim 21 wherein said transferring operation comprises:
reading said data from said external system memory.

23. The method as defined in claim 21 wherein said transferring operation comprises:
storing said data in said external system memory.

24. The method as defined in claim 20 wherein said outputting operation comprises:
returning said data to said processor from said external system memory.

25. The method as defined in claim 20 wherein said outputting operation comprises:
returning a signal to indicate whether said data was stored successfully in said external system memory.

26. A machine-readable medium having stored thereon a plurality of executable instructions to perform a method comprising:
receiving a processor request to transfer data;
performing the data transfer using a system memory located external to said processor; and
outputting a result of the data transfer.

27. The machine-readable medium as defined in claim 26 wherein said transferring operation comprises:
storing said data in said external system memory.

28. The machine-readable medium as defined in claim 27 wherein said transferring operation comprises:
reading said data from said external system memory.

29. The machine-readable medium as defined in claim 26 wherein said outputting operation comprises:
returning said data to said processor from said external system memory.

30. A docking station comprising:
a system memory;
a system memory bus coupled to said system memory; and
a system memory docking link coupled to said system memory bus.

31. The docking station as defined in claim 30 wherein said system memory is to receive power from said docking station.

32. The docking station as defined in claim 30 wherein said system memory is to receive power from an external source.

33. The docking station as defined in claim 32 wherein said external source is a portable device.

34. The docking station as defined in claim 30 wherein said external source is a portable computer.

35. The docking station as defined in claim 30 wherein said docking station further comprises:
a docking station docking interface; and
a docking station bus coupled to said docking station docking interface.
